(19) United States
(12) Patent Application Publication
(10) Pub. No.: US 2014/0223904 A1
(43) Pub. Date: Aug. 14, 2014

(54) PULSE TURBINE TURBOCHARGER AND EGR SYSTEM

(71) Applicants: Terry G. Wood, Countryside, IL (US); Timothy M. Lyons, Batavia, IL (US)

(72) Inventors: Terry G. Wood, Countryside, IL (US); Timothy M. Lyons, Batavia, IL (US)

(73) Assignee: International Engine Intellectual Property Company, LLC, Lisle, IL (US)

(21) Appl. No.: 14/240,510

(22) PCT Filed: Aug. 26, 2011
(86) PCT No.: PCT/US11/49412

§ 371 Date: Feb. 24, 2014

(51) Int. Cl. F02B 37/00

(52) U.S. Cl. CPC F02B 37/004
USPC 60/612; 60/273

(57) ABSTRACT

A method of boosting air to an intake manifold (20) of an engine (16) having cylinders (C) that emit exhaust gas includes the steps of dividing the exhaust gas emitted from the cylinders into a first exhaust passageway (26A) and a second exhaust passageway (26B), and fluidly communicating at least a portion of the exhaust gas (EG1) from the first exhaust passageway to a divided turbocharger (28). The method also includes the steps of fluidly communicating at least a portion of the exhaust gas (EG1) from the second exhaust passageway (26B) to the divided turbocharger (28), and fluidly communicating the exhaust gas from the divided turbocharger to an undivided turbocharger (42). Further steps in boosting the air include compressing air (CA) at a compressor (48) of the undivided turbocharger (42), and fluidly communicating the compressed air to the intake manifold (20).

### BACKGROUND

Embodiments described herein relate to a system for boosting air through a turbocharger and directing exhaust gases through an EGR system.

In six-cylinder engines having a front exhaust manifold divided from a rear exhaust manifold, the exhaust gases from the front three cylinders are isolated from the rear three cylinders. The exhaust gases exit from both the front exhaust manifold and the rear exhaust manifold into a turbocharger turbine inlet, which typically is a single, open channel that allows the exhaust gases from the front exhaust manifold and the rear exhaust manifold to communicate. This communication of the exhaust gas is known as a “short circuit”, and the short circuit can reduce the exhaust pulse energy at the turbocharger. The exhaust pulse energy is used to drive up the turbine efficiency at low speeds, increasing boost pressure for a given exhaust manifold pressure.

EGR systems associated with engines having a divided exhaust manifold also use exhaust back pressure to drive exhaust gas flow through the EGR system back to an intake manifold. However, the communication of the exhaust gases from the front exhaust manifold and the rear exhaust manifold at the turbocharger turbine inlet can reduce the exhaust back pressure, which can also reduce the drive of exhaust gas flow through the EGR system. Exhaust gas flow through the EGR system improves transient emissions.

### SUMMARY

A turbocharger and EGR system for a vehicle having an engine with a plurality of cylinders emitting exhaust gas includes a divided exhaust manifold in downstream fluid communication from the plurality of cylinders, and a first exhaust gas passageway in downstream fluid communication from the divided exhaust manifold and in upstream fluid communication from a turbocharger. The system also includes a second exhaust gas passageway in downstream fluid communication from the divided exhaust manifold and in upstream fluid communication from the turbocharger. The second exhaust gas passageway is also in upstream fluid communication from an intake manifold of the engine.

A dual stage turbocharger system for a vehicle having an engine with a plurality of cylinders emitting exhaust gas includes a divided exhaust manifold in downstream fluid communication from the plurality of cylinders, and a divided turbocharger in downstream fluid communication from the divided exhaust manifold. A first exhaust gas passageway is in downstream fluid communication from the divided exhaust manifold and is in upstream fluid communication from the divided turbocharger. A second exhaust gas passageway is in downstream fluid communication from the divided exhaust manifold and in upstream fluid communication from the divided turbocharger. An undivided turbocharger is in downstream fluid communication from the divided turbocharger.

A method of boosting air to an intake manifold of an engine having cylinders that emit exhaust gas includes the steps of dividing the exhaust gas emitted from the cylinders into a first exhaust passageway and a second exhaust passageway, and fluidly communicating at least a portion of the exhaust gas from the first exhaust passageway to a divided turbocharger. The method also includes the steps of fluidly communicating at least a portion of the exhaust gas from the second exhaust passageway to the divided turbocharger, and fluidly communicating the exhaust gas from the divided turbocharger to an undivided turbocharger. Further steps in boosting the air include compressing air at a compressor of the undivided turbocharger, and fluidly communicating the compressed air to the intake manifold.

### BRIEF DESCRIPTION OF THE DRAWINGS

FIG. 1 is a schematic of a turbocharger and EGR system.

### DETAILED DESCRIPTION

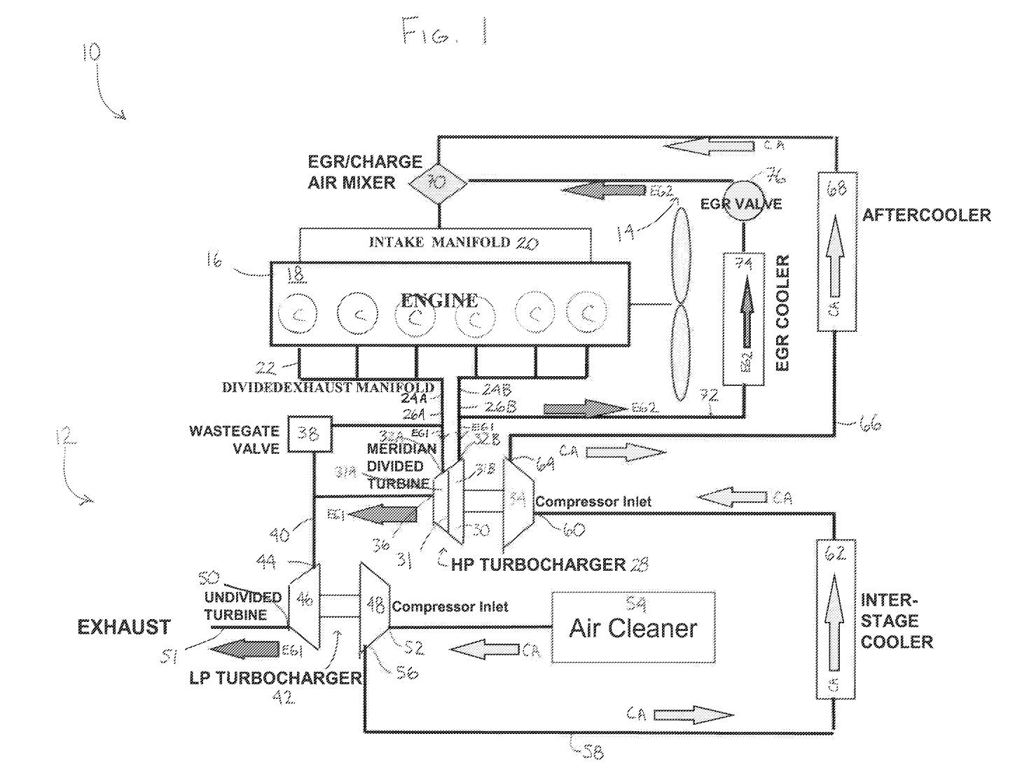

Referring to FIG. 1, a turbocharger and EGR system is indicated generally at 10 and includes a two-stage turbocharger system 12 and an exhaust gas recirculation (EGR) system 14, both of which are in downstream fluid communication with an engine 16. The two-stage turbocharger system 12 uses the pulse energy of the exhaust gas EG emitted from the engine. The engine 16 has a block 18 that includes a plurality of cylinders C fluidly connected to an intake manifold 20 and to a divided exhaust manifold 22.

The divided exhaust manifold 22 may have a common discharge flange that includes two discharge ports, one port to a first pipe 24A from half of the plurality of cylinders C, and a second port to a second pipe 24B from the other half of the plurality of cylinders, however other configurations are possible. Although an engine 16 with an inline arrangement of six cylinders is illustrated, inline, V-arrangements, or other arrangements of plural cylinders of any number of cylinders are also encompassed by the invention. Exhaust gas EG from the rear three cylinders C may be communicated from the divided exhaust manifold 22 through a first exhaust gas passageway 26A to the two-stage turbocharger system 12, and exhaust gas from the forward three cylinders may be communicated from the divided exhaust manifold through a second exhaust gas passageway 26B to the EGR system 14, although other arrangements of cylinders to the exhaust gas passageways are possible.

A high-pressure turbocharger 28 is located on the first exhaust gas passageway 26A and includes a divided turbine 30 having a first inlet port 32A in downstream fluid communication from the first exhaust gas passageway. A second inlet port 32B of the high-pressure turbocharger 28 is in downstream fluid communication with the second exhaust gas passageway 26B. A flow divider 31 may divide the exhaust gas passageway into two turbine volute passageways 31A, 31B. The two turbine volute passageways 31A, 31B may have a different size, although it is possible that the passageways may be generally equally sized. Specifically, the volute passageway 31B downstream of an EGR line 72, may be sized to be smaller than the passageway 31A since a portion of the exhaust gas EG is diverted to the EGR system 14 upstream of the volute passageway 31A. The isolated passageways 31A, 31B prevent the communication of the exhaust gas from the front and rear engine cylinders. Further, it is possible that multiple flow dividers may divide the exhaust passageway into any number of turbine passageways. As the exhaust gas EG1 is fluidly communicated in pulses, the divided turbine 30 uses the pulse energy from the two separate exhaust gas passageways 26A and 26B to increase the efficiency of the turbine. An optional valve can be disposed upstream of the divided turbine 30 and may be used for limiting or decreasing turbine output and therefore limiting or decreasing intake manifold pressure. The high-pressure turbocharger 28 includes a compressor 34 coupled to the turbine 30, where the turbine is in upstream fluid communication from the intake manifold 20.

The exhaust gas EG1 exits the high-pressure turbocharger 28 at an outlet port 36. A wastegate valve 38 may divert exhaust gases EG1 from first exhaust gas passageway 26A, regulating the turbine 30 speed, which in turn regulates the rotating speed of a compressor 34. The wastegate valve 38 allows the regulation of the maximum boost pressure to protect the engine 16 and the turbocharger 28 from excess boost pressure. In addition to or instead of the wastegate valve 38, it is also possible that a second wastegate valve may be in fluid communication with the exhaust passageway 26B and upstream of the second inlet port 32B.

From the outlet port 36, the exhaust gas EG1 is communicated on an inter-turbine line 40 to a low-pressure, undivided turbocharger 42. Additionally, exhaust gas EG1 from wastegate valve 38 may be communicated on the inter-turbine line 40 to the low-pressure turbocharger 42. Having a single inlet port 44, the low-pressure turbocharger 42 has an undivided turbine 46 that is coupled to a compressor 48. Exhaust gas EG1 leaves the turbine 46 at an outlet 50, and may exit the dual-stage turbocharger system 12 through a tailpipe 51. Emissions and sound treating components can be arranged to receive the exhaust gas EG1 from the tailpipe 51, before exhausting to the atmosphere, as is known.

During operation of the engine 16, air may enter the compressor 48 through an air inlet 52. Upstream of the air inlet 52 may be an air cleaner 54. Compressed air CA may exit the compressor 48 through an air outlet 56 and be communicated on an inter-compressor line 58 to an air inlet 60 of the compressor 34 of the high-pressure turbocharger 28 where the air is further compressed. Between the compressor 48 and the compressor 34, the compressed air CA may pass through an inter-stage cooler 62.

From an air outlet 64 of the compressor 34, the air CA is communicated through an inlet air line 66 to the intake manifold 20. The air CA may pass through an optional aftercooler 68 before entering an intake air/EGR mixer 70. Downstream of the intake air mixer 70 is the intake manifold 20, followed by the cylinders C.

A stream of exhaust gas EG2 from the second exhaust gas passageway 26B may be routed through the EGR line 72, through an EGR cooler 74, and through an EGR valve 76 before meeting and mixing with boost air from the inlet air line 66 at the intake air/EGR mixer 70. An amount of exhaust gas EG2 being re-circulated through the EGR valve 76 may depend on a controlled opening percentage of the EGR valve.

The turbocharger and EGR system 10 having a fixed geometry two-stage turbocharger system 12 provides greater back pressure and greater exhaust pulse energy for improved transient response and improved vehicle launch characteristics. Further, transient emissions are reduced and low and mid-speed fuel economy may be improved with the turbocharger and EGR system 10.

What is claimed is:

1) A turbocharger and EGR system for a vehicle having an engine with a plurality of cylinders emitting exhaust gas, the system comprising:
a divided exhaust manifold in downstream fluid communication from the plurality of cylinders;
a first exhaust gas passageway in downstream fluid communication from the divided exhaust manifold and in upstream fluid communication from a turbocharger; and
a second exhaust gas passageway in downstream fluid communication from the divided exhaust manifold and in upstream fluid communication from the turbocharger, the second exhaust gas passageway also in upstream fluid communication from an intake manifold of the engine.

2) The turbocharger and EGR system of claim 1 wherein the turbocharger is a divided turbocharger.

3) The turbocharger and EGR system of claim 2 wherein the turbocharger receives pulses of exhaust gas from the first exhaust gas passageway at a first inlet, and the turbocharger receives pulses of exhaust gas from the second exhaust gas passageway at a second inlet.

4) The turbocharger and EGR system of claim 1 further comprising a second turbocharger in downstream fluid communication from the turbocharger on an inter-turbine line for receiving exhaust gas from the first exhaust gas passageway and the second exhaust gas passageway.

5) The turbocharger and EGR system of claim 4 further comprising a wastegate valve for diverting exhaust gas from the turbocharger on an inter-turbine line.

6) The turbocharger and EGR system of claim 4 wherein air is compressed at the second turbocharger and fluidly communicated from the second turbocharger on an inter-compressor line to the turbocharger.

7) The turbocharger and EGR system of claim 6 wherein the air is compressed at the turbocharger and fluidly communicated from the turbocharger to the intake manifold on an air inlet line.

8) The turbocharger and EGR system of claim 1 wherein the first exhaust gas passageway receives exhaust gas from half of the plurality of cylinders, and wherein the second exhaust gas passageway receives exhaust gas from a second half of the plurality of cylinders.

9) The turbocharger and EGR system of claim 1 wherein the first exhaust gas passageway receives exhaust gas from a rear half of the plurality of cylinders, and wherein the second exhaust gas passageway receives exhaust gas from a front half of the plurality of cylinders.

10) The turbocharger and EGR system of claim 1 further comprising an EGR line in fluid communication with the second exhaust gas passageway for fluidly communicating the exhaust gas to the intake manifold.

11) A dual stage turbocharger system for a vehicle having an engine with a plurality of cylinders emitting exhaust gas, the system comprising:
a divided exhaust manifold in downstream fluid communication from the plurality of cylinders;
a divided turbocharger in downstream fluid communication from the divided exhaust manifold;
a first exhaust gas passageway in downstream fluid communication from the divided exhaust manifold and in upstream fluid communication from the divided turbocharger;
a second exhaust gas passageway in downstream fluid communication from the divided exhaust manifold and in upstream fluid communication from the divided turbocharger; and
an undivided turbocharger in downstream fluid communication from the divided turbocharger.

12) The dual stage turbocharger system of claim 11 wherein the divided turbocharger further comprises a first inlet in fluid communication with the first exhaust passageway, and a second inlet in fluid communication with the second exhaust passageway.

13) The dual stage turbocharger system of claim 12 wherein the first inlet receives exhaust gas from rear half of the plurality of cylinders, and wherein the second inlet receives exhaust gas from a front half of the plurality of cylinders.

14) The dual stage turbocharger system of claim 11 further comprising a wastegate valve in downstream fluid communication with the first exhaust passageway.

15) The dual stage turbocharger system of claim 11 wherein air is compressed at the undivided turbocharger and fluidly communicated from the undivided turbocharger on an inter-compressor line to the divided turbocharger.

16) The dual stage turbocharger system of claim 15 wherein the air is compressed at the divided turbocharger and fluidly communicated from the divided turbocharger to the intake manifold on an air inlet line.

17) A method of boosting air to an intake manifold of an engine having cylinders that emit exhaust gas, the method comprising the steps:
dividing the exhaust gas emitted from the cylinders into a first exhaust passageway and a second exhaust passageway;
fluidly communicating at least a portion of the exhaust gas from the first exhaust passageway to a divided turbocharger;
fluidly communicating at least a portion of the exhaust gas from the second exhaust passageway to the divided turbocharger;
fluidly communicating the exhaust gas from the divided turbocharger to an undivided turbocharger;
compressing air at a compressor of the undivided turbocharger; and
fluidly communicating the compressed air to the intake manifold.

18) The method of claim 17 further comprising the step of pulsing the exhaust gas fluidly communicated through the first exhaust passageway, and pulsing the exhaust gas fluidly communicated through the second exhaust passageway.

19) The method of claim 17 further comprising the step of fluidly communicating the compressed air from the undivided turbocharger to a compressor of the divided turbocharger, and fluidly communicating the compressed air from the divided turbocharger to the intake manifold.

20) The method of claim 17 further comprising the step of fluidly communicating at least a portion of the exhaust gas from the second exhaust gas passageway on an EGR line to the intake manifold.
